(19) United States
(12) Patent Application Publication
(10) Pub. No.: US 2008/0307092 A1
(43) Pub. Date: Dec. 11, 2008

(54) METHOD AND APPARATUS FOR DETERMINING WHETHER CONTENT IS USABLE

(75) Inventors: Won-seok KWON, Suwon-si (KR); Hyoung-shick KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/134,708

(22) Filed: Jun. 6, 2008

Related U.S. Application Data
(60) Provisional application No. 60/942,479, filed on Jun. 7, 2007.

(30) Foreign Application Priority Data
Feb. 5, 2008 (KR) 10-2008-0011893

(51) Int. Cl. G06F 15/173

(52) U.S. Cl. 709/225

(57) ABSTRACT

Provided is a method of determining whether content provided from a first device is available to a second device in a network including the first and second devices. In the method, content domain information indicating a domain in which use of content provided from a first device is allowed is obtained from the first device, device domain information indicating a domain to which the second device belongs is obtained from the second device, the content domain information and the device domain information are compared to determine whether they are identical to each other, whether the content is available to the second device is determined based on the result of comparing.

### CROSS-REFERENCE TO RELATED PATENT APPLICATIONS

This application claims priority from U.S. Provisional Application No. 60/942,479, filed on Jun. 7, 2007 in the U.S. Patent and Trademarks Office, and Korean Patent Application No. 10-2008-0011893, filed on Feb. 5, 2008, in the Korean Intellectual Property Office, the disclosure of which are incorporated herein in its entirety by reference.

### BACKGROUND OF THE INVENTION

1. Field of the Invention

Method and apparatuses consistent with the present invention relate to determining whether content received from a first device is available to a second device in a network including, at least, the first device and the second device.

2. Description of the Related Art

With the spread of home networking, a conventional personal computer (PC)-based network environment has changed to an environment employing various lower network techniques. Microsoft Inc. (MS) has suggested the Universal Plug and Play (UPnP) technique in order to meet a need for a technique for networking electric home appliances in an independent and unified manner by using an Internet protocol (IP). The UPnP technique is based on a dispersed and open networking construction and thus can allow peer-to-peer networking between electric home appliances in a home network without centralized management thereof.

A UPnP network using the UPnP technique may include a media server that provides content, a media renderer that reproduces the content received from the media server, and a control point that controls the media server and the media renderer.

In this case, if the content provided from the media server has a format that the media renderer cannot reproduce, the control point must control the content not to be reproduced by the media renderer. Thus, a technique of determining whether content received from a media server can be reproduced before a media renderer reproduces the content has been developed.

FIG. 1 is a flowchart illustrating a related art method of determining whether content is available to a media renderer. In operation 110, first format information regarding formats of content that the media renderer can reproduce is obtained from the media renderer.

In this case, a control point may obtain the first format information by transmitting a UPnP action GetProtocolInfo( ) to the media renderer and then extracting the first format information from protocol information received from the media renderer in response to the UPnP action.

In operation 120, second format information regarding a format of content that a media server provides is obtained from the media server.

In this case, the control point may obtain the second format information by extracting it from content metadata received from the media server.

In operation 130, the first format information and the second format information are compared with each other in order to determine whether the content provided from the media server can be reproduced in the media renderer.

For example, if the formats of content that the media renderer can reproduce are MP3, AVI, and MP4 and the format of the content that the media server provides is MPEG, the control point determines that the media renderer cannot reproduce the content provided from the media server media renderer.

If the content provided from the media server is set to be reproduced by only a plurality of devices belonging to a predetermined domain, a device that does not belong to the domain cannot the reproduce the content. For example, a device belonging to a domain B cannot reproduce content that has been allowed to be reproduced by only devices belonging to a domain A.

In the related art, whether content can be reproduced by a media renderer is determined by simply comparing the format of content provided from a media server with a format of content that the media renderer can reproduce. Thus, it is impossible to determine whether the media renderer can reproduce content that has been allowed to be reproduced only within a predetermined domain.

Further, there has not been developed a method of obtaining information regarding the domain in which the content can be reproduced and information regarding a domain to which the media renderer belongs.

### SUMMARY OF THE INVENTION

Exemplary embodiments of the present invention provide a method and apparatus for determining whether content that has been allowed to be used only within a predetermined domain is available to a device.

According to an aspect of the present invention, there is provided a method of determining whether content provided from a first device is available to a second device in a network including, at least, the first device and the second device, the method comprising obtaining content domain information from the first device, where the content domain information indicates a domain in which use of the content from the first device is allowed; obtaining device domain information from the second device, where the device domain information indicates a domain to which the second device belongs; comparing whether the content domain information is identical to the device domain information; and determining whether the content is available to the second device, based on the result of comparing.

The obtaining of the content domain information may comprise receiving content metadata from the first device, where the content metadata includes the content domain information and information related to the content; and extracting the content domain information from the content metadata.

The obtaining of the device domain information may comprise receiving device specification information from the second device, where the device specification information includes the device domain information and information related to the second device; and extracting the device domain information from the device specification information.

The method may further include selecting one of a plurality of pieces of content that the first device provides, wherein during the determining of whether the content is available to the second device, it is determined whether the selected piece of content is available to the second device.

If the result of comparing reveals that the device domain information is identical to the content domain information, the method may further include judging whether the second device has a right to use the selected content, wherein the determining of whether the content is available to the second device comprises determining whether the content is available to the second device, based on the result of judging.

The judging of whether the second device has a right to use the selected content may be performed based on content use control information, where the content use control information includes at least one of a number of times that the content is to be used and a period of time that the content is to be used.

The content use control information may be read from the second device or received from the first device.

The determining of whether the content is available to the second device may comprise determining that the content is available to the second device when the device domain information is identical to the content domain information.

The method may further include informing the second device of a message stating that the content is available to the second device when it is determined that the content is available to the second device.

The network may be a universal plug and play (UPnP) network, the first device may be a UPnP media server, and the second device may be a UPnP media renderer.

According to another aspect of the present invention, there is provided an apparatus for determining whether content provided from a first device is available to a second device in a network including, at least, the first device and the second device, the apparatus comprising an information obtaining unit receiving content domain information from the first device and device domain information from the second device, where the content domain information represents a domain in which use of the content of the first device is allowed and the device domain information represents a domain to which the second device belongs; a comparison unit comparing whether the content domain information is identical to the device domain information; and a determination unit determining whether the content is available to the second device based on the result of comparing.

The information obtaining unit may comprise a receiving unit receiving content metadata from the first device, where the content metadata includes the content domain information and information related to the content; and an extraction unit extracting the content domain information from the content metadata.

The method may further include a selection unit selecting one of a plurality of pieces of content that the first device provides, wherein the determination unit determines whether the selected content is available to the second device.

The method may further include a judging unit judging whether the second device has a right to use the selected content when the result of comparing reveals that the device domain information is identical to the content domain information, wherein the determination unit determines whether the content is available to the second device based on the result of judging.

According to another aspect of the present invention, there is provided a computer readable medium having recorded thereon a computer program for executing a method of determining whether content provided from a first device is available to a second device in a network including, at least, the first device and the second device, the method comprising obtaining content domain information from the first device, where the content domain information indicates a domain in which use of the content from the first device is allowed; obtaining device domain information from the second device, where the device domain information indicates a domain to which the second device belongs; comparing whether the content domain information is identical to the device domain information; and determining whether the content is available to the second device, based on the result of comparing.

### BRIEF DESCRIPTION OF THE DRAWINGS

The above and other exemplary aspects and advantages of the present invention will become more apparent by the following detailed description of exemplary embodiments thereof with reference to the attached drawings in which:

FIG. 1 is a flowchart illustrating a related art method of determining whether content is available in a media renderer;

FIG. 2 is a block diagram of an apparatus for determining whether content is available according to an exemplary embodiment of the present invention;

FIG. 3 is a block diagram of an information obtaining unit illustrated in FIG. 2 according to an exemplary embodiment of the present invention;

FIG. 4 illustrates content metadata according to an exemplary embodiment of the present invention;

FIG. 5 illustrates device specification information according to an exemplary embodiment of the present invention;

FIG. 6 is a flowchart illustrating a method of determining whether content is available according to an exemplary embodiment of the present invention; and

FIG. 7 is a block diagram illustrating an application of a method of determining whether content is available according to an exemplary embodiment of the present invention.

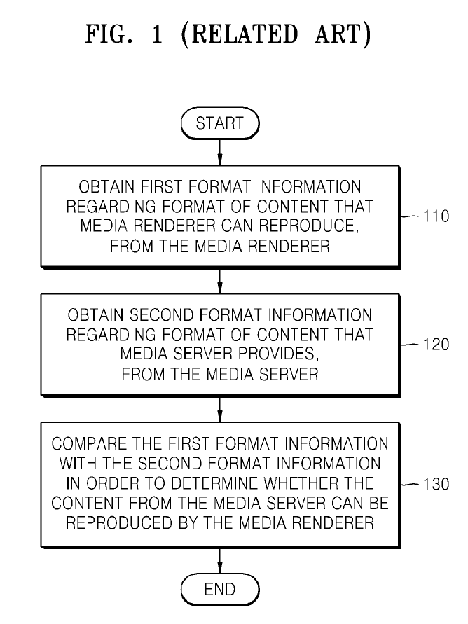

### DETAILED DESCRIPTION OF EXEMPLARY EMBODIMENTS OF THE INVENTION

Exemplary embodiments of the present invention will now be described in greater detail with reference to the accompanying drawings.

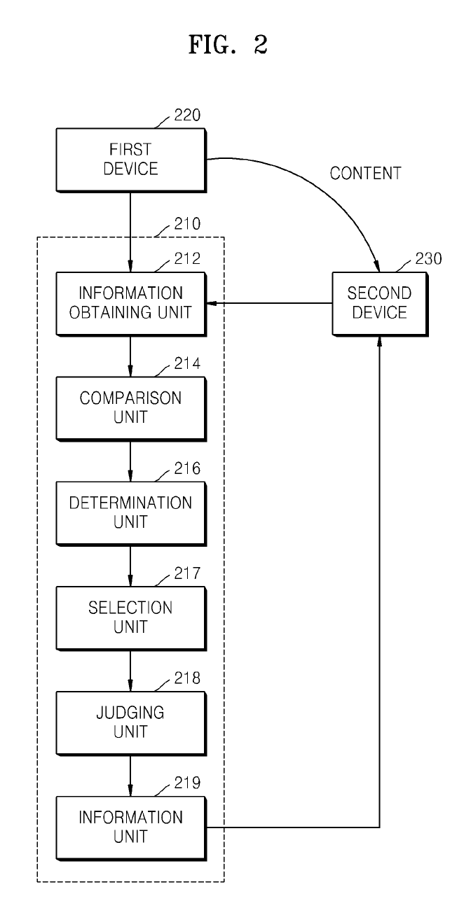

FIG. 2 is a block diagram of an apparatus 210 for determining whether content is available (“the determining apparatus”) according to an exemplary embodiment of the present invention. For convenience of explanation, a first device 220 and a second device 230 are further illustrated in FIG. 2.

Here, the first device 220 provides content to the second device 230, and the second device 230 uses the content received from the first device 220. Also, it is assumed that the content provided from the first device 220 is available to only a device belonging to a predetermined domain.

Referring to FIG. 2, the determining apparatus 210 includes an information obtaining unit 212, a comparison unit 214, a determination unit 216, a selection unit 217, a judging unit 218, and an information unit 219.

The information obtaining unit 212 obtains content domain information from the first device 220, where the content domain information indicates a domain in which the content provided from the first device can be used.

Also, the information obtaining unit 212 obtains device domain information from the second device 230, where the device domain information indicates a domain to which the second device 230 belongs.

The operation of the information obtaining unit 212 will later be described in greater detail with reference to FIGS. 3 through 5.

The comparison unit 214 compares whether the content domain information and the device domain information obtained by the information obtaining unit 212 are identical to each other.

The determination unit 216 determines whether the second device 230 can use the content, based on the comparison result received from the comparison unit 214.

That is, the determination unit 216 determines that the second device 230 can use the content when the device domain information is identical to the content domain information, and determines that the second device 230 cannot use the content when the device domain information is not identical to the content domain information.

For example, assuming that a content domain representing the domain in which the content can be used is a domain A and a device domain representing the domain to which the second device 230 belongs is the domain A, determination unit 216 determines that the second device 230 can use the content. However, if the domain to which the second device 230 belongs is a domain B, determination unit 216 determines that the second device 230 cannot use the content.

In this case, if the first device 210 provides a plurality of pieces of content, the pieces of the content may be allowed to be used in only different domains. In this case, it is possible to either determine whether all the pieces of the content are available to the second device 230 or determine whether content selected from among the pieces of the content is available to the second device 230,

For example, if content A, B, and C can be respectively used in domains A, B, and C, it is possible to select the content A and then determine whether the content A can be used in the second device 230 belonging to the domain B. In this case, the determination unit 230 may determine that the content A cannot be used in the second device 230 but may not make any determination with respect to the content B and the content C.

The determining apparatus 210 may further have a selection unit 217 that selects one from among a plurality of pieces of content that the first device 210 provides.

Alternatively, even if the determination unit 216 determines that the content is available to the second device 230, use of the content may be limited.

For example, if the content provided from the first device 210 is allowed to be used only a predetermined number of times or within a predetermined period of time, there must be a restriction to use of the content by the second device 230. Thus, there is a need for determining whether the second device 230 has a right to use the content before the second device 230 uses the content provided from the first device 220.

According to an exemplary embodiment of the present invention, the determining apparatus 210 may further include a judging unit 218 that judges whether the second device 230 has a right to use the content provided from the first device 220.

The judging unit 218 may judge whether the second device 230 has a right to use the content, based on content use control information including at least one of a number of times that the content can be used and a period of time that the content can be used. In this case, if the content use control information is stored in the second device 230, the judging unit 218 reads it from the second device 230. However, if the content use control information is stored in the first device 220, the judging unit 218 may receive it from the first device 220.

For example, if a movie A can be reproduced only four times and the second device 230 reproduced the movie A three times, the movie A can be reproduced once more and thus, the second device 230 has a right to reproduce the movie A. However, if the second device 230 has already reproduced the movie A four times, the second device 230 does not have a right to reproduce the movie A.

In a case where the judging unit 218 judges that the second device 230 has a right to use the content, a message stating that the content is available to the second device 230 may be informed to the second device 230. In the other cases, a message stating that the content is not available to the second device 230 may be informed to the second device 230.

Alternatively, the determining apparatus 210 may further include an information unit 219 that informs the second device 230 of a message stating whether the content is available to the second device 230.

A network that the determining apparatus 210, the first device 220 and the second device 230 form together may be a UPnP network but is not limited thereto.

The operation of the information obtaining unit 212 will now be described in greater detail with reference to FIGS. 3 through 5.

FIG. 3 is a block diagram illustrating in detail the information obtaining unit 212 illustrated in FIG. 2 according to an exemplary embodiment of the present invention. Referring to FIG. 3, the information obtaining unit 212 includes a receiving unit 212a and an extraction unit 212b.

The receiving unit 212a receives content metadata that includes content domain information and information related to content, from the first device 220.

Alternatively, the receiving unit 212a may receive only the content domain information excluding the content metadata. In this case, the extraction unit 212b can be omitted.

The extraction unit 212b extracts content domain information from the content metadata received via the receiving unit 212a.

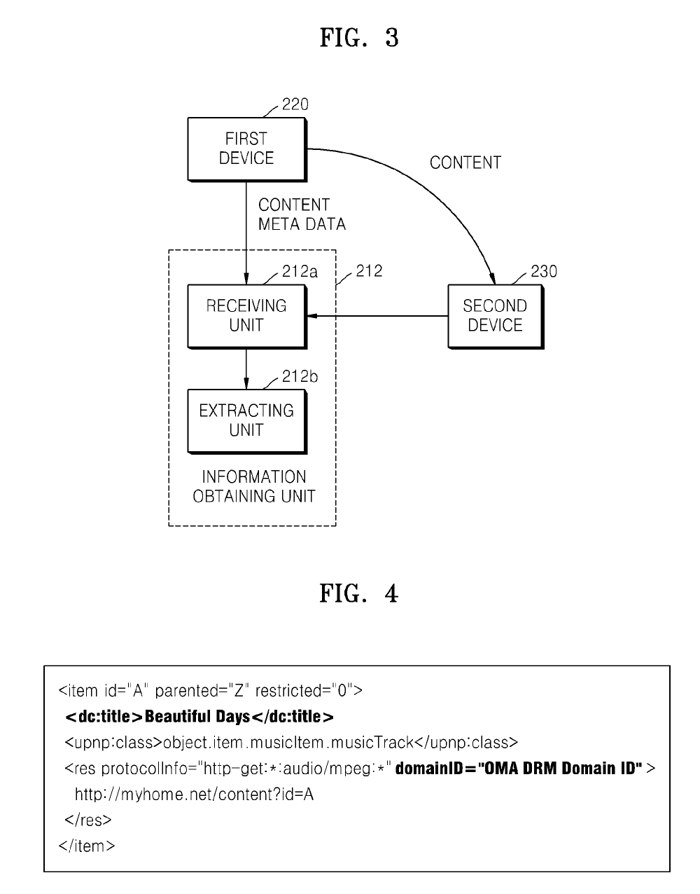

FIG. 4 illustrates content metadata according to an exemplary embodiment of the present invention. Referring to FIG. 4, “<dc:title>Beautiful Days</dc:title>” represents that the title of content is ‘Beautiful Days’.

‘domainID=“OMA DRM Domain ID”’ represents a content domain identifier indicating a domain in which use of the content is allowed. If ‘domainID=“OMA DRM Domain A”’, the domain in which the use of the content is allowed is a domain A protected according to an OMA standard-based digital right management (DRM) method. Thus, a device belonging to a domain B cannot use the content.

Accordingly, according to the current exemplary embodiment, content domain information, such as a content domain identifier, is included into content metadata so as to provide a determining apparatus according to the present invention with information regarding a domain in which use of content is allowed.

As described above, the information obtaining unit 212 obtains not only content domain information but also device domain information from the second device 230.

Referring to FIG. 3, the receiving unit 212a receives device specification information that includes device domain information and information regarding the second device 230, from the second device 230.

Alternatively, the receiving unit 212a may receive the device domain information excluding the device specification information. In this case, the extraction unit 212b can be omitted.

The extraction unit 212b extracts the device domain information from the device specification information via the receiving unit 212a.

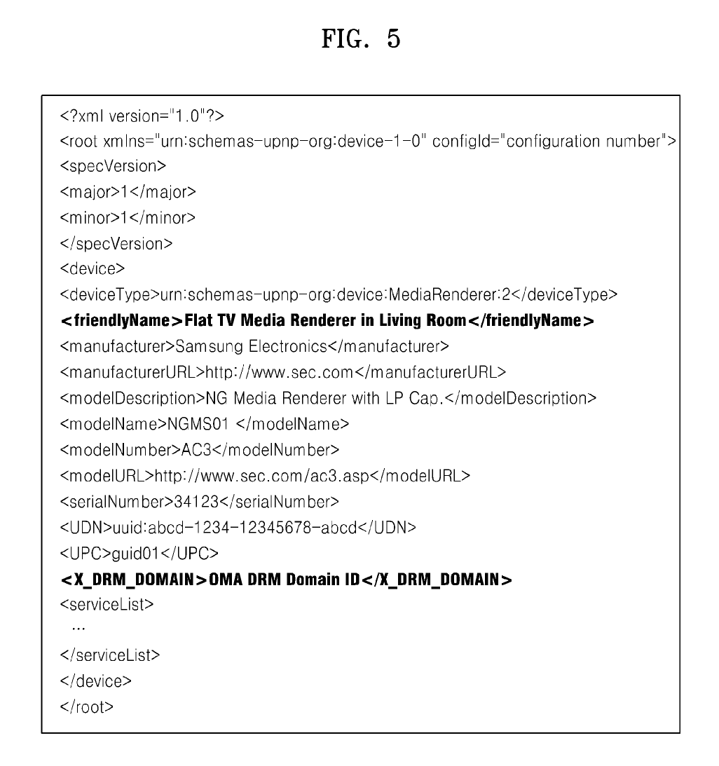

FIG. 5 illustrates device specification information according to an exemplary embodiment of the present invention. Referring to FIG. 5, “<friendlyName>Flat TV Media renderer in Living Room</friendlyName>” represents that the name of a device installed in a living room is a flat TV media renderer.

“<X_DRM_DOMAIN>OMA DRM Domain ID</X_DRM_DOMAIN>” represents the identifier of a device domain to which the device belongs. “<X_DRM_DOMAIN>OMA DRM Domain A</X_DRM_DOMAIN>” means that the device belongs to a domain A protected according to the OMA standard-based DRM method.

As described above, according to the current exemplary embodiment, device domain information, such as a device domain identifier, is included in device specification information so as to provide a determining apparatus according to the present invention with information regarding a domain to which the second device 230 belongs.

Alternatively, if the information obtaining unit 212 fails to receive content domain information and/or device domain information due to an error in the first device 220 and the second device 230, an error message stating that the above information was not received due to the error may be displayed.

The determining apparatus may further include an output unit (not shown) that outputs an error message.

A method of determining whether content provides from a first device is available to a second device in a network including the first device and the second device, will now be described.

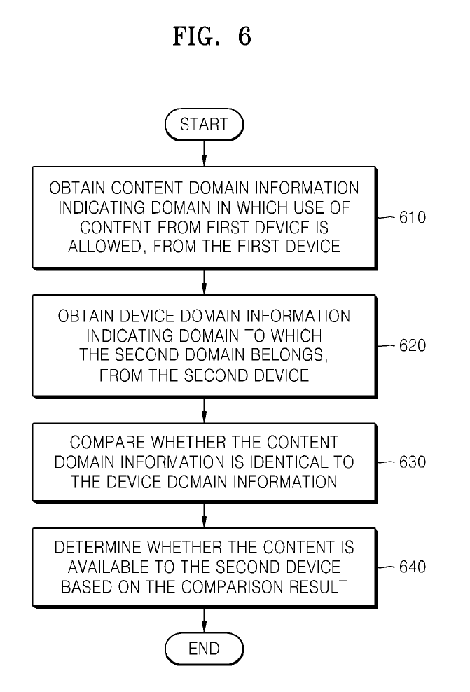

FIG. 6 is a flowchart illustrating a method of determining whether content is available according to an exemplary embodiment of the present invention. In operation 610, content domain information is received from a first device, where the content domain information indicates a domain in which use of content provided from the first device is allowed.

In operation 620, device domain information is obtained from a second device, where the device domain information indicates a domain to which the second domain belongs.

In operation 630, the content domain information and the device domain information are compared in order to determine whether they are identical to each other.

In operation 640, it is determined whether the second device can use the content based on the comparison result.

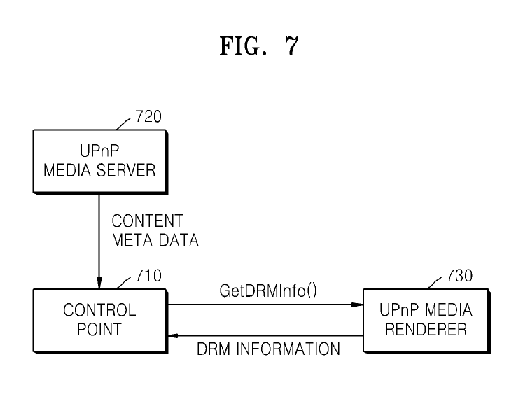

FIG. 7 is a block diagram illustrating an application of a method of determining whether content is available according to an exemplary embodiment of the present invention. In FIG. 7, a control point 710 receives content metadata regarding content that is to be provided from a UPnP media server 720 to a UPnP media renderer 730, from the UPnP media server 720, and then extracts content domain information from the content metadata.

Next, the control point 710 transmits a GetDRMInfo( ) action to the UPnP media renderer 730. The GetDRMInfo( ) action is an action defined to request the UPnP media renderer 730 to provide DRM information related to the UPnP media renderer 730. In this case, the DRM information may include device domain information representing a domain to which the UPnP media renderer 730 belongs, and a uniform resource locator (URL) for receiving use control information regarding the content protected according to a DRM method.

The control point 710 receives the DRM information from the UPnP media renderer 730 and extracts device domain information from the DRM information, in response to the GetDRMInfo( ) action.

Alternatively, the control point 710 may request the DRM information by accessing a control URL of the UPnP media renderer 730 so as to receive the DRM information from the UPnP media renderer 730, without using the GetDRMInfo( ) action.

The control point 710 compares a content domain and a device domain, which are determined as described above, with each other and then determines whether the content provided from the UPnP media server 720 is available to the UPnP media renderer 730.

If the content provided from the UPnP media server 720 is available to the UPnP media renderer 730, the control point 710 may inform the UPnP media renderer 730 of a message stating that the content is available to the UPnP media renderer 730.

The above exemplary embodiments of the present invention may be embodied as a computer program, and stored in a computer readable medium, and executed using a general digital computer. Examples of the computer-readable medium include a magnetic recording medium (a ROM, a floppy disk, a hard disc, etc.), and an optical recording medium (a CD-ROM, a DVD, etc.).

The above exemplary embodiments of the present invention may also be embodied as carrier waves (such as in transmission over the Internet), which can be further interpreted and executed by a general digital computer.

According to the above exemplary embodiments of the present invention, it is possible to determine whether content that is available only within a predetermined domain can be used in a device.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of determining whether content provided from a first device is available to a second device in a network which comprises the first device and the second device, the method comprising:
obtaining content domain information from the first device, wherein the content domain information indicates a domain in which use of the content from the first device is allowed;
obtaining device domain information from the second device, wherein the device domain information indicates a domain to which the second device belongs;
comparing whether the content domain information is identical to the device domain information; and
determining whether the content is available to the second device, based on the result of comparing.

2. The method of claim 1, wherein the obtaining the content domain information comprises:
receiving content metadata from the first device, wherein the content metadata comprises the content domain information; and
extracting the content domain information from the content metadata.

3. The method of claim 1, wherein the obtaining the device domain information comprises:
receiving device specification information from the second device, wherein the device specification information comprises the device domain information; and
extracting the device domain information from the device specification information.

4. The method of claim 1, wherein the content provided from the first devices comprises a plurality of pieces of content, the method further comprising:
selecting one piece of content from the plurality of pieces of content,
wherein during the determining whether the content is available to the second device, it is determined whether the selected content is available to the second device.

5. The method of claim 1, further comprising if the result of the comparing reveals that the device domain information is identical to the content domain information, judging whether the second device has a right to use the selected content,
wherein the determining whether the content is available to the second device comprises determining whether the content is available to the second device, based on a result of the judging.

6. The method of claim 5, wherein the judging whether the second device has the right to use the selected content is performed based on content use control information, wherein the content use control information includes at least one of a number of times that the content is to be used and a period of time that the content is to be used.

7. The method of claim 6, wherein the content use control information is read from the second device or received from the first device.

8. The method of claim 1, wherein if the device domain information is identical to the content domain information, the determining whether the content is available to the second device comprises determining that the content is available to the second device.

9. The method of claim 8, further comprising if it is determined that the content is available to the second device, informing the second device that the content is available to the second device.

10. The method of claim 1, wherein the network is a Universal Plug and Play (UPnP) network, the first device is a UPnP media server, and the second device is a UPnP media renderer.

11. An apparatus for determining whether content provided from a first device is available to a second device in a network which comprises the first device and the second device, the apparatus comprising:
an information obtaining unit which receives content domain information from the first device and device domain information from the second device, wherein the content domain information represents a domain in which use of the content of the first device is allowed and the device domain information represents a domain to which the second device belongs;
a comparison unit which compares whether the content domain information is identical to the device domain information; and
a determination unit which determines whether the content is available to the second device based on a result of the comparison by the comparison unit.

12. The apparatus of claim 11, wherein the information obtaining unit comprises:
a receiving unit which receives content metadata from the first device, wherein the content metadata comprises the content domain information; and
an extraction unit which extracts the content domain information from the content metadata.

13. The apparatus of claim 12, wherein the receiving unit receives device specification information from the second device, the device specification information comprises the device domain information, and
the extraction unit extracts the device domain information from the device specification information.

14. The apparatus of claim 11, wherein the content provided from the first device comprises a plurality of pieces of content, the apparatus further comprising a selection unit which selects one of a plurality of pieces of content that the first device provides,
wherein the determination unit determines whether the selected content is available to the second device.

15. The apparatus of claim 11, further comprising a judging unit which judges whether the second device has a right to use the selected content if the result of the comparison reveals that the device domain information is identical to the content domain information,
wherein the determination unit determines whether the content is available to the second device based on a result of the judging by the judging unit.

16. The apparatus of claim 15, wherein the judging unit judges whether the second device has a right to use the selected content, based on content use control information including at least one of a number of times that the content is to be used and a period of time that the content is to be used.

17. The apparatus of claim 16, wherein the content use control information is received from the second device or received from the first device.

18. The apparatus of claim 11, wherein the determination unit determines that the content is available to the second device if the device domain information is identical to the content domain information.

19. The apparatus of claim 18, further comprising an informing unit which informs the second device that the content is available to the second device if it is determined that the content is available to the second device.

20. The apparatus of claim 11, wherein the network is a Universal Plug and Play UPnP (universal plug and play) network, the first device is a UPnP media server, and the second device is a UPnP media renderer.

21. A computer readable medium having recorded thereon a computer program for executing the method of claim 1.
